(19) United States
(12) Patent Application Publication
(10) Pub. No.: US 2022/0058580 A1
(43) Pub. Date: Feb. 24, 2022

(54) Cryptocurrency Protocol and System and Method for Use of Same

(71) Applicant: Arkitoken, Inc., Highlands Ranch, CO (US)

(72) Inventor: Michael Revy, Highlands Ranch, CO (US)

(21) Appl. No.: 17/087,452

(22) Filed: Nov. 2, 2020

Related U.S. Application Data
(60) Provisional application No. 63/069,619, filed on Aug. 24, 2020.

(51) Int. Cl. G06Q 10/10; G06Q 40/00; G06Q 20/38; G06Q 20/06; G06Q 40/04; G06Q 20/40; G06Q 40/02; G06F 16/23

(52) U.S. Cl. CPC G06Q 10/10; G06Q 40/12; G06Q 20/389; G06Q 20/0655; G06Q 2220/00; G06Q 20/4037; G06Q 40/02; G06Q 20/405; G06F 16/2379; G06Q 40/04

(57) ABSTRACT

A cryptocurrency protocol and system and method for use of the same are disclosed. In one embodiment of the cryptocurrency protocol, a contingent financial transaction request is received. A blockchain addition mapping to a distributed accounting subledger of interest is performed to create contingent stored value. This blockchain addition mapping includes the contingent financial transaction request entered as an appended pair of contingent accounting entries including a corresponding debit entry and credit entry with validation detail data. If the appended pair of contingent accounting entries are validated, a blockchain addition mapping to a distributed accounting ledger of interest is performed to enter the contingency financial transaction request as an appended pair of accounting entries including the corresponding debit entry and credit entry.

### PRIORITY STATEMENT & CROSS-REFERENCE TO RELATED APPLICATIONS

This application claims priority from co-pending U.S. Patent Application Ser. No. 63/069,619 entitled “Cryptocurrency Token and System and Method for Use of Same” filed on Aug. 24, 2020, in the name of Michael Revy; which is hereby incorporated by reference, in entirety, for all purposes.

### TECHNICAL FIELD OF THE INVENTION

This invention relates, in general, to cryptocurrency and, in particular, to cryptocurrency protocols establishing rules for tokens with specific uses that reside on a blockchain to provide a user with a blockchain account with cryptocurrency functions other than making payments.

### BACKGROUND OF THE INVENTION

Cryptocurrency markets that allow for secure digital payments are denominated by cryptocurrency tokens, which utilize ledger entries internal to a particular cryptocurrency. Cryptocurrency markets are projected to continue to display robust growth represented by an estimated double-digit compound annual growth rate. As a result of the continued forecasted growth of cryptocurrency, there is a need for cryptocurrency protocols that establish rules for tokens with more robust ledger functionality.

### SUMMARY OF THE INVENTION

It would be advantageous to a cryptocurrency protocol that establishes rules for tokens, and the like, and a system and method for use of the same for providing cryptocurrency functions other than making payments. It would be desirable to enable a decentralized, distributed digital ledger and software solution that would provide enhanced accounting functionality. To better address one or more of these concerns, a cryptocurrency protocol and a system and method for use of the same are disclosed. In one embodiment of the cryptocurrency protocol, a contingent financial transaction request is received. A blockchain addition mapping to a distributed accounting subledger of interest is performed to create contingent stored value. This blockchain addition mapping includes the contingent financial transaction request entered as an appended pair of contingent accounting entries including a corresponding debit entry and credit entry with validation detail data. If the appended pair of contingent accounting entries are validated, a blockchain addition mapping to a distributed accounting ledger of interest is performed to enter the contingency financial transaction request as an appended pair of accounting entries including the corresponding debit entry and credit entry.

In another aspect, the cryptocurrency protocol may be utilized to provide double-entry bookkeeping or triple-entry bookkeeping. In a further aspect, the cryptocurrency protocol may be utilized to fungible contingent stored values. In a still further another aspect, the cryptocurrency protocol may be incorporated into a system or methodology providing for contingent store values on the blockchain. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is schematic network diagram depicting one embodiment of a system utilizing a cryptocurrency protocol for enhanced accounting functionality, according to the teachings presented herein;

FIG. 2 is a schematic network diagram depicting another embodiment of a system utilizing a cryptocurrency protocol for enhanced accounting functionality, according to the teachings presented herein;

FIG. 3 is a functional block diagram depicting one embodiment of an application stack including the cryptocurrency protocol presented in FIGS. 1 and 2;

FIG. 4 is a functional flow diagram depicting one embodiment of the cryptocurrency protocol presented in FIG. 3 being utilized to perform enhanced accounting functionality;

FIG. 5 is a functional block diagram depicting one embodiment of a cryptocurrency protocol server presented in FIGS. 1 and 2;

FIG. 6 is a functional flow conceptual diagram depicting one detailed embodiment of the cryptocurrency protocol being utilized in a double-entry bookkeeping application;

FIG. 7 is a functional flow conceptual diagram depicting another detailed embodiment of the cryptocurrency protocol being utilized in a double-entry bookkeeping application;

FIG. 8 is a functional flow conceptual diagram depicting one detailed embodiment of the cryptocurrency protocol being utilized in a triple-entry bookkeeping application;

FIG. 9 is a functional flow conceptual diagram depicting one detailed embodiment of the cryptocurrency protocol being utilized in a fungible stored value application; and

FIG. 10 is a flow chart depicting one embodiment of a methodology for utilizing the cryptocurrency protocol with a cryptocurrency token, according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

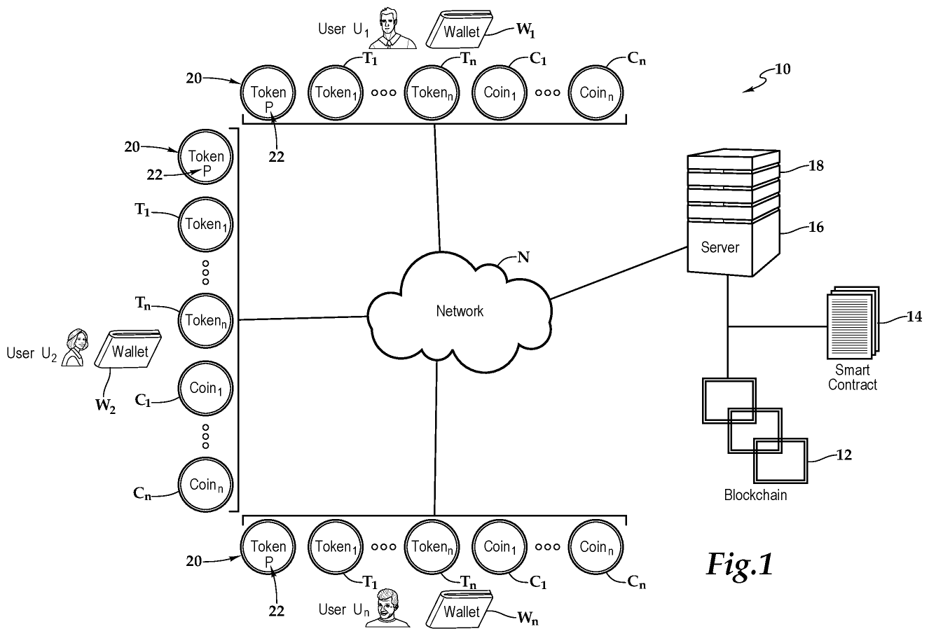

Referring initially to FIG. 1, therein is depicted one embodiment of a system executing enhanced accounting functionality, which is schematically illustrated and designated 10. A blockchain 12 represents a shared ledger on which a cryptocurrency market relies. Confirmed transactions are included in the blockchain 12 and the integrity and chronological order of transactions on the blockchain 12 may be enforced with cryptography. That is, the blockchain 12 may be embodied as a growing list of records, called blocks, which are linked using cryptography. Each block may contain a cryptographic hash of the previous block, a timestamp, and transaction data, for example. In this way, the blockchain 12 is an encrypted, consensual, immutable, online, peer-to-peer distributed ledger, whose maintenance generates cryptocurrency. The blockchain 12 may be utilized as a store of value as well as a means to store transactions between accounts and other data and programs.

A smart contract 14 runs on the blockchain 12. The smart contract 14 may be embodied as a computer protocol intended to digitally facilitate, verify, or enforce the negotiation or performance of a contract. In general, smart contracts allow the performance of credible transactions without third parties. These transactions are trackable and irreversible, and the contractual clauses may be made partially or fully self-executing, self-enforcing, or both. One aim of smart contracts is to provide security that is superior to traditional contract law and to reduce other transaction costs associated with contracting. As shown, in some embodiments, the smart contract 14 defines the shared logic to execute operations on the blockchain 12. The blockchain 12 and the smart contract 14 may be embodied on a server 16, which is one embodiment of a cryptocurrency token server 18. A network N, such as the Internet, connects users, including user U₁, user U₂, and user Uₙ, to the server 16. It should be appreciated that any number of users may be connected together by the network N.

The user U₁ has a cryptocurrency wallet W₁, which provides the private keys necessary to access the digital currency belonging to the user U₁ on the blockchain 12. The user U₁ also has cryptocurrency coins C₁ through Cₙ. The various cryptocurrency coins C₁ through Cₙ act like money: as a unit of account, store of value and medium of transfer. Cryptocurrency coins C₁ through Cₙ may take the form of native blockchain tokens like bitcoin (BTC) and Litecoin (LTC), for example. The user U1 may also have cryptocurrency tokens T₁ through Tₙ. The cryptocurrency tokens T₁ through Tₙ provide specific uses that reside on the blockchain 12 to provide the user U₁ with a blockchain account with cryptocurrency functions other than making payments. In this way, the cryptocurrency tokens T₁ through Tₙ may be considered as autonomous computer programs that are stored on the blockchain 12 and execute various commands that may result in transactions recorded on the blockchain 12.

It should be appreciated that user U₁, like users U₂ and Uₙ, may have any combination of wallets, cryptocurrency coins, and cryptocurrency tokens. The user U₁ also has a cryptocurrency token 20 that, in addition to functions associated with cryptocurrency tokens T₁ through Tₙ, provides a contingent stored value by utilizing a cryptocurrency protocol 22. The contingent stored value may, in turn, be utilized to provide double-entry bookkeeping, triple-entry bookkeeping, or a fungible contingent stored value, for example. The user U₂, similar to the user U₁, has a wallet W₂ having access to cryptocurrency coins C₁ through Cₙ, cryptocurrency tokens T1 through Tn, and the cryptocurrency token 20 operating with the cryptocurrency protocol 22. Lastly, the user Uₙ, similar to the user Uₙ, has a wallet Wₙ having access to cryptocurrency coins C₁ through Cₙ, cryptocurrency tokens T₁ through Tₙ, and the cryptocurrency token 20 operating with the cryptocurrency protocol 22.

The cryptocurrency protocol 22 may be a set of crypto-economic rules that maintain distributed consensus across the network N. By way of example, with respect to the user U₁, the cryptocurrency protocol 22 allows the user U₁ to manage his or her data. Further, in one embodiment, the cryptocurrency protocol 22 supports the user U₁ creating an account by way of the wallet Wi that may then be used to pay for services and execute financial transactions, for example. The cryptocurrency protocol 22 may define the rules, syntax, semantics and synchronization of communication over the network N and possible error recovery methods, among other functionalities typically associated with a communication protocol. In particular, as will be described in further detail hereinbelow, the cryptocurrency protocol 22 enables a shared accounting protocol for the blockchain 12 furnishing a decentralized, distributed digital ledger and software solution that provides enhanced accounting functionality, such as, for example, double-entry bookkeeping or triple-entry bookkeeping and creation and management of a fungible contingent stored value.

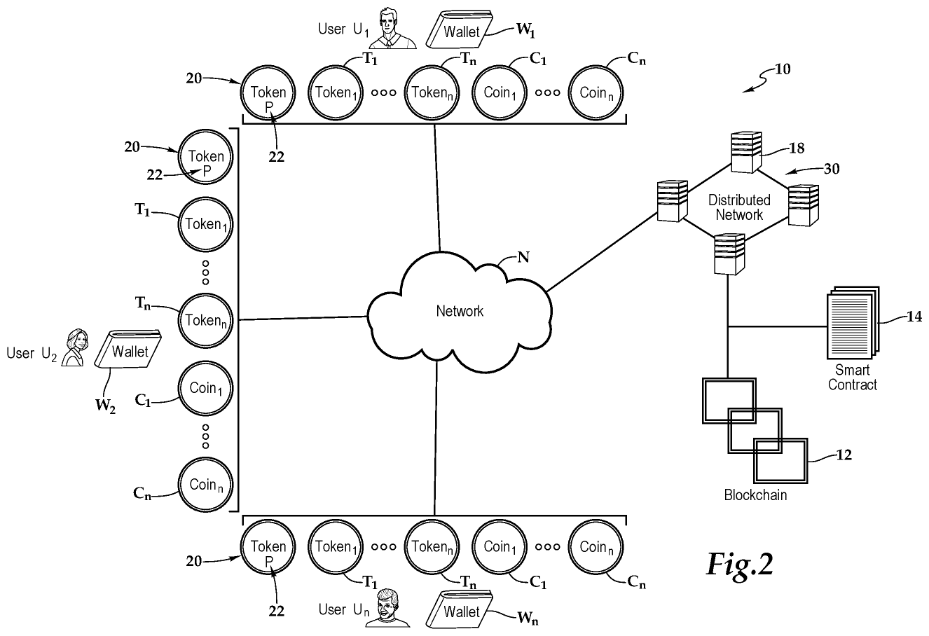

FIG. 2 depicts another embodiment of the system that executes system executing enhanced accounting functionality and contingent stores of value. Similar to FIG. 1, the blockchain 12 provides a distributed ledger with the smart contract 14 running on the blockchain 12. The blockchain 12 and the smart contract 14 may be embodied, however, on a distributed network 30, which is also one embodiment of the cryptocurrency token server 18. The network N connects the users U₁ though Uₙ to the distributed network 30. Briefly, as previously discussed, the respective users U₁ . . . Uₙ have respective wallets W₁ . . . Wₙ having access to the cryptocurrency coins C₁ through Cₙ, the cryptocurrency tokens T₁ through Tₙ, and the cryptocurrency token 20 operating with the cryptocurrency protocol 22.

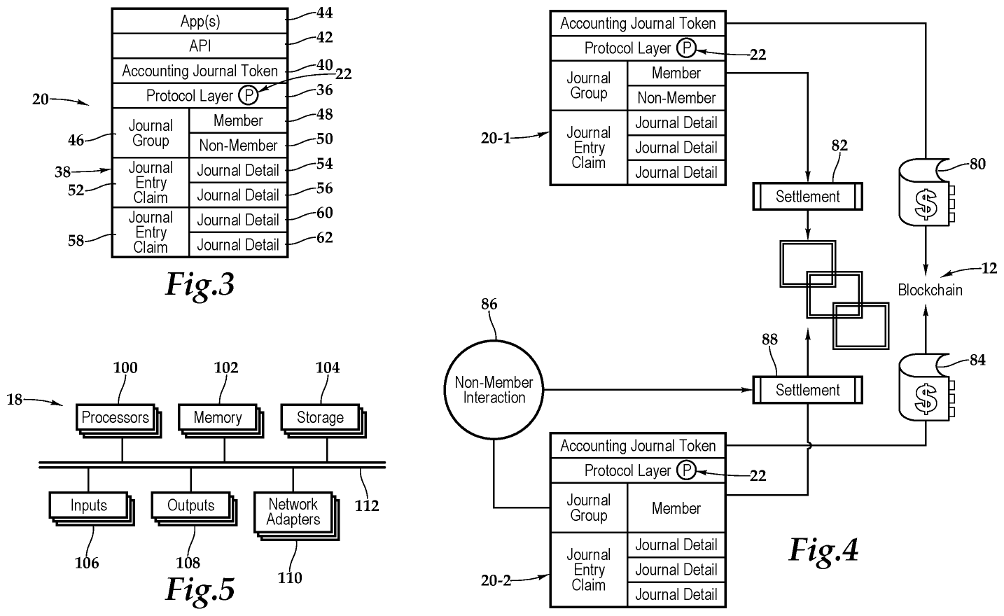

Referring now to FIG. 3, the cryptocurrency token 20 operating on the cryptocurrency protocol 22 is embodied as an accounting journal token 40 that provides consumer finance utility and credit by, in part, creating contingent stores of value. The functionality of the accounting journal token 40 that is enabled by the cryptocurrency protocol 22 may be accessed via an application program interface 42 that supports one or more applications 44, commonly known as “Apps.” By way of example and not by way of limitation, the applications 44 may include a Lending App that allows a creating member of the respective cryptocurrency wallet or the cryptocurrency token 20 to offer a lending facility in response to an outside member request. The Lending App may manage and document any transaction that may occur and appropriately maintains the blockchain 12 with new lendings, repayments, rejections, and the like. By way of further example, the applications 44 may include a Budget App that allows members to manage multi-input budgets having common expenses.

More generally, FIG. 3 depicts one embodiment of an application stack including the cryptocurrency protocol 22. A protocol layer 36, which may be a decentralized protocol layer, sits on top of a data layer 38. The protocol layer 36, which houses the cryptocurrency protocol 22 and other protocols, provides a protocol stack with the necessary collection of modules of software that together combine to produce the software suite or software suites that allows communication and consensus across the network N according to the crypto-economic rules established by the cryptocurrency protocol 22. The protocol layer 36 may be of any thickness. That is, the protocol layer 36 may be thin to allow only operation of a few types of tokens and applications or the protocol layer 36 may be thick to allow for an operation of many types of tokens and applications. The data layer 38 is also a shared layer that provides applications 44 with varying levels of access via the tokens 20, T₁ . . . Tₙ, and the like as well as the protocol layer 36 by to data on the blockchain 12. A portion of the blockchain 12 is represented in the data layer 38 by the various journal groups, member lists, non-member lists, and journal entry claims, and journal details which are described hereinbelow.

Continuing with the discussion of the data layer 38, the accounting journal token 40 may maintain several lists. A journal group 46 includes a member list 48 and a non-member list 50. The member list 48 is a list of insiders including the accounting journal token 40 creator or creators. The inside members on the member list 48 may become liable for any created journal item requests. The non-member list 50 includes a listing of outside creditors or debtors to the accounting journal token 40. Such outside membership may include recognized outside vendors and service providers, for example. A journal entry claim may be created by any member or non-member of the accounting journal token 40 as maintained on the member list 48 and the non-member list 50. The journal entry claim 52 may be a single-entry accounting item with initially no offsetting accounting entry or entries. The journal entry claim 52 may describe an expected or already paid for item or service as a contingent claim against the accounting journal token 40.

The journal entry claim 52 may contain a pointer or other mechanism to point to any underlying documentation like loan documents or an invoice, for example. The pointer, by way of example, may incorporate an InterPlanetary File System hash key, which provides a protocol and peer-to-peer network for storing and sharing data in a distributed file system. If the journal entry claim 52 is created by a member, it advances from single-entry accounting to double-entry accounting. On the other hand, if the journal entry claim 52 is created by a non-member, then additional verification is required to move from single-entry accounting to double-entry accounting.

The journal entry claim 52 includes journal details 54, 56, which provide a breakdown of the journal entry claim 52 per any or all of the members of the accounting journal token 40. More specifically, the journal details 54, 56 describe the stored contingent value required to satisfy all or some portion of the related journal item claim. This includes details to make the double-entry accounting such that a contingency claim may be available for settlement. The journal details 54, 56 may also include a state of the claim, which relates to the validation. Forms of validation may be established at the creation of the accounting journal token 40 and may be pending, repaid, rejected, or partially repaid, for example. In one implementation, utilizing the one or more applications 44, a user may execute a change in the state of the accounting journal token 40 such that a contingent claim described in a journal detail, such as journal details 54, 56, becomes an executed transaction of the blockchain 12. In this implementation, balances are not maintained on the accounting journal token 40; rather, balances are maintained on the blockchain 12, which may be a public or private blockchain.

Further, if a claim is not validated, then the claim will be marked as such in journal details 54, 56. As shown in FIG. 3, any number of journal entry claims having any number of journal details may be associated with the data layer 28 and the accounting journal token 40 operating with the cryptocurrency protocol 22. In the illustrated instance, the accounting journal token 40 also includes journal entry claim 58 having journal details 60 62. Presently, direct payment is possible for users of blockchain. Users may also request funds on the blockchain from other users. Blockchain alone, however, cannot keep lists of contingent claims for groups or simple lists of contingent claim stored value balances for record and settlement purposes as transactions.

The accounting journal token 40 utilizing the cryptocurrency protocol 22 allows for a distinct blockchain of contingent claims to be maintained and, if validated, settled on the larger and more accessible blockchain. In this manner, the accounting journal token 40 utilizing the cryptocurrency protocol 22 permits the grouping and management of credits and debits for an entire or specified part of a larger project. The accounting journal token 40 utilizing the cryptocurrency protocol 22, via the application program interface 42 and the one or more applications 44, may provide various reminders, notices, and invites for payment or action to members. The accounting journal token 40 utilizing the cryptocurrency protocol 22 can also track member contingent claim history and payment behavior. With such history available, the accounting journal token 40 utilizing the cryptocurrency protocol 22 may perform analytic functions like credit metrics, liquidity analysis, and audits.

Referring now to FIG. 4, in one embodiment of the cryptocurrency token 20 utilizing the cryptocurrency protocol 22, a contingent financial transaction request is established by a cryptocurrency token 20-1, which is similar in structure and function to the cryptocurrency token 20 presented in FIG. 3. A blockchain addition mapping to a distributed accounting subledger of interest is performed to create contingent stored value. This blockchain addition mapping includes the contingent financial transaction request entered as an appended pair of contingent accounting entries including a corresponding debit entry and credit entry with validation detail data. If the appended pair of contingent accounting entries are validated and settled at a settlement 82, then a blockchain addition mapping to a distributed accounting ledger of interest, which forms a portion of the blockchain 12, is performed to enter the contingency financial transaction request as an appended pair of accounting entries including the corresponding debit entry and credit entry on the blockchain 12.

Continuing to refer to FIG. 4, in one embodiment of the cryptocurrency token 20 utilizing the cryptocurrency protocol 22, a contingent financial transaction request is established by a cryptocurrency journal token 20-2, which is similar in structure and function to the cryptocurrency journal token 20 presented in FIG. 3. A blockchain addition mapping to a distributed accounting subledger of interest 84 is performed to create contingent stored value after the transaction is initiated via non-member interaction 86 with the non-member interaction 86 validated by a member of the cryptocurrency token 20-2. This blockchain addition mapping includes the contingent financial transaction request entered as an appended pair of contingent accounting entries including a corresponding debit entry and credit entry with validation detail data. If the appended pair of contingent accounting entries are validated and settled at a settlement 88, then a blockchain addition mapping to a distributed accounting ledger of interest, which forms a portion of the blockchain 12, is performed to enter the contingency financial transaction request as an appended pair of accounting entries including the corresponding debit entry and credit entry on the blockchain 12.

Referring now to FIG. 5, one embodiment of the cryptocurrency token server 18 as one or more computing devices includes processors 100, memory 102, storage 104, inputs 106, outputs 108, and network adapters 110 interconnected with various buses 112 in a common or distributed, for example, mounting architecture. In these implementations, in the computing device, multiple processors and/or multiple buses may be used, as appropriate, along with multiple memories and types of memory. Further still, in other implementations, multiple computing devices may be provided and operations distributed therebetween. The processors 100 may process instructions for execution within the cryptocurrency token server 18, including instructions stored in the memory 102 or in the storage 104. The memory 102 stores information within the computing device. In one implementation, the memory 102 is a volatile memory unit or units. In another implementation, the memory 102 is a non-volatile memory unit or units. The storage 104 includes capacity that is capable of providing mass storage for the cryptocurrency token server 18. The memory 102 and the storage 104 may store various aspects of the protocol layer 36, including the cryptocurrency protocol 22. Various inputs 106 and outputs 108 provide connections to and from the cryptocurrency token server 18, wherein the inputs 106 are the signals or data received by the cryptocurrency token server 18, and the outputs 108 are the signals or data sent from the cryptocurrency token server 18. The network adapters 110 couple the cryptocurrency token server 18 to a network, such as the network N of FIG. 1 and FIG. 2, such that the cryptocurrency token server 18 may be part of a network of computers, a local area network (LAN), a wide area network (WAN), an intranet, a network of networks, or the Internet, for example.

The memory 102 and the storage 104 are accessible to the processors 100 and include processor-executable instructions that, when executed, cause the processors 100 to execute a series of operations. The processor-executable instructions work in conjunction with the smart contract running on the blockchain that is utilizing the cryptocurrency protocol presented herein. In one embodiment, the blockchain stores distributed accounting subledgers and each of the distributed accounting subledgers includes pairs of accounting entries having a corresponding debit entry to a first account and credit entry to a second account. The distributed accounting subledgers may be accessible on the blockchain via the cryptocurrency token. The blockchain also stores distributed accounting ledgers with pairs of accounting entries that have a corresponding debit entry to a first account and credit entry to a second account. The distributed accounting ledgers are accessible, either publicly or privately depending on the type of blockchain, on the blockchain.

In one embodiment of first processor-executable instructions, the processor-executable instructions cause the processor or processors, as represented by the processors 100 to receive a contingent financial transaction request and, responsive thereto, to request from the smart contract a blockchain addition mapping to a distributed accounting subledger of interest. The blockchain addition mapping includes the contingent financial transaction request entered as an appended pair of contingent accounting entries including a corresponding debit entry and credit entry with validation detail data.

If the appended pair of contingent accounting entries are validated, the processor-executable instructions cause the cryptocurrency token to request from the smart contract a blockchain addition mapping to a distributed accounting ledger of interest. This blockchain addition mapping includes the contingency financial transaction request entered as an appended pair of accounting entries including the corresponding debit entry and credit entry.

In one embodiment of second processor-executable instructions, the processor-executable instructions cause the processor or processors, as represented by the processors 100 to, if the appended pair of contingent accounting entries are unvalidated, request from the smart contract a blockchain addition mapping to the distributed accounting subledger of interest. The blockchain addition mapping includes the contingent financial transaction request re-entered as an appended pair of non-validated accounting entries including the corresponding debit entry and credit entry.

In one embodiment of third processor-executable instructions, the processor-executable instructions cause the processor or processors, as represented by the processors 100 to, if the appended pair of contingent accounting entries are unvalidated, non-request to the smart contract a blockchain addition mapping to the distributed accounting ledger of interest. In one embodiment of fourth processor-executable instructions, the processor-executable instructions cause the processor or processors, as represented by the processors 100 to, if the appended pair of contingent accounting entries are unvalidated, request from the smart contract a blockchain addition mapping to the distributed accounting subledger of interest. The blockchain addition mapping includes the contingent financial transaction request re-entered as an appended pair of non-validated accounting entries including the corresponding debit entry and credit entry. Further, the processor-executable instructions cause the cryptocurrency token, via the cryptocurrency protocol, to, if the appended pair of contingent accounting entries are unvalidated, non-request to the smart contract a blockchain addition mapping to the distributed accounting ledger of interest.

In one embodiment of fifth processor-executable instructions, the processor-executable instructions cause the processor or processors, as represented by the processors 100 to receive a contingent financial transaction request and request from the smart contract a blockchain addition mapping to a distributed accounting subledger of interest. The blockchain addition mapping includes the contingent financial transaction request entered as an appended pair of contingent accounting entries including a corresponding debit entry and credit entry with validation detail data. The processor-executable instructions then cause the processors 100 to enable fungibility of the pair of contingent accounting entries including a corresponding debit entry and credit entry with validation detail data. If the appended pair of contingent accounting entries are validated, the processor 100 is caused to request from the smart contract a blockchain addition mapping to a distributed accounting ledger of interest. The blockchain addition mapping includes the contingency financial transaction request entered as an appended pair of accounting entries including the corresponding debit entry and credit entry.

In one embodiment of sixth processor-executable instructions, the processor-executable instructions cause the processor or processors, as represented by the processors 100 to, receive a contingent financial transaction request and then request from the smart contract a blockchain addition mapping to a distributed accounting subledger of interest. The blockchain addition mapping including the contingent financial transaction request entered as an appended pair of contingent accounting entries including a corresponding debit entry and credit entry with validation detail data. The processor-executable instructions then cause the processors 100 to, if the appended pair of contingent accounting entries are at least partially validated, request from the smart contract a blockchain addition mapping to a distributed accounting ledger of interest. The blockchain addition mapping includes the contingency financial transaction request proportionately entered, in accordance with the partial validation, as an appended pair of accounting entries including the corresponding debit entry and credit entry.

As presented herein, the processor-executable instructions enable both double-entry bookkeeping and triple-entry bookkeeping. With respect to double-entry bookkeeping, double-entry bookkeeping is enabled when a first distributed accounting subledger belongs to a first party and the first distributed accounting subledger includes pairs of accounting entries with the pairs of accounting entries including a corresponding debit entry to a first account and credit entry to a second account. A second distributed accounting subledger belongs to a second party and the second distributed accounting subledger includes pairs of accounting entries with the pairs of accounting entries including a corresponding debit entry to a first account and credit entry to a second account. Triple-entry bookkeeping is enabled when one of the debit entries of the first distributed accounting ledger serves as one of the credit entries of the second distributed accounting ledger.

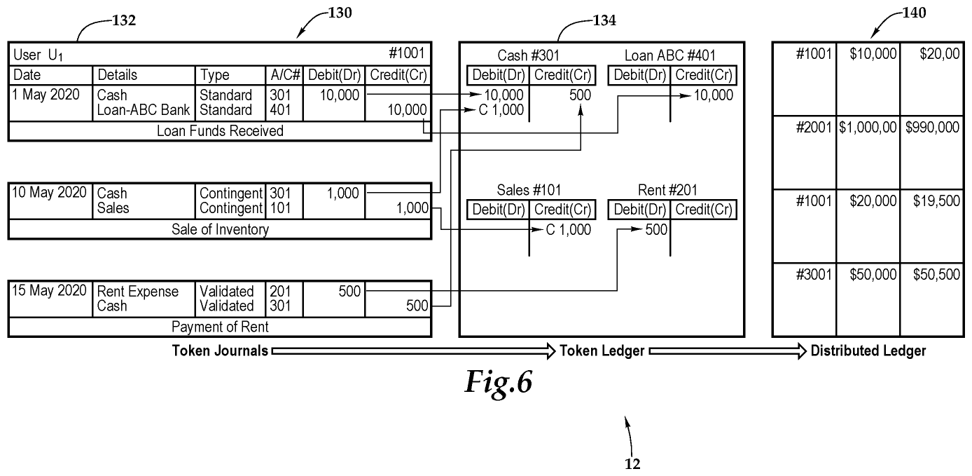

Referring now to FIG. 6, one conceptualization of the cryptocurrency token 20 with the cryptocurrency protocol 22 being utilized in a double-entry bookkeeping application is depicted. The blockchain 12 includes a distributed subledger 130 accessible to the cryptocurrency token 20 via, in part, the cryptocurrency protocol 22. As shown, in one embodiment, the subledger 130 includes a token journal portion 132 and a token ledger portion 134. A distributed ledger 140 forms part of the blockchain 12 and is generally more accessible than the distributed subledger 130. The user U₁ is an account holder of account #1001 and utilizes the cryptocurrency token to receive a loan from ABC bank, which is recorded in a double-entry bookkeeping fashion in the token journal portion 132 and the token ledger portion 134. The loan is also represented on the distributed ledger 140 of the blockchain 12, with account #1001 of the user U₁ increasing by $10,000 and an account #2001 owned by ABC Bank decreasing by $10,000. The user U₁ has a contingent stored value created with respect to the sale of inventory. This contingent transaction was initiated by the user U₁ and is reflected as “Contingent” in the token journal portion 132 and as contingent with a “C” in the token ledger portion. As this transaction is not settled, an exchange of money is not reflected in the distributed ledger 140. Also, the user U₁ has a rent expense, which was contingent but is now validated. This rent expense is reflected in the token journal portion 132, the token ledger portion 134, and the distributed ledger 140 with the account belonging to the User U₁ being debited $500 and the landlord's account, account #3001, being credited $500.

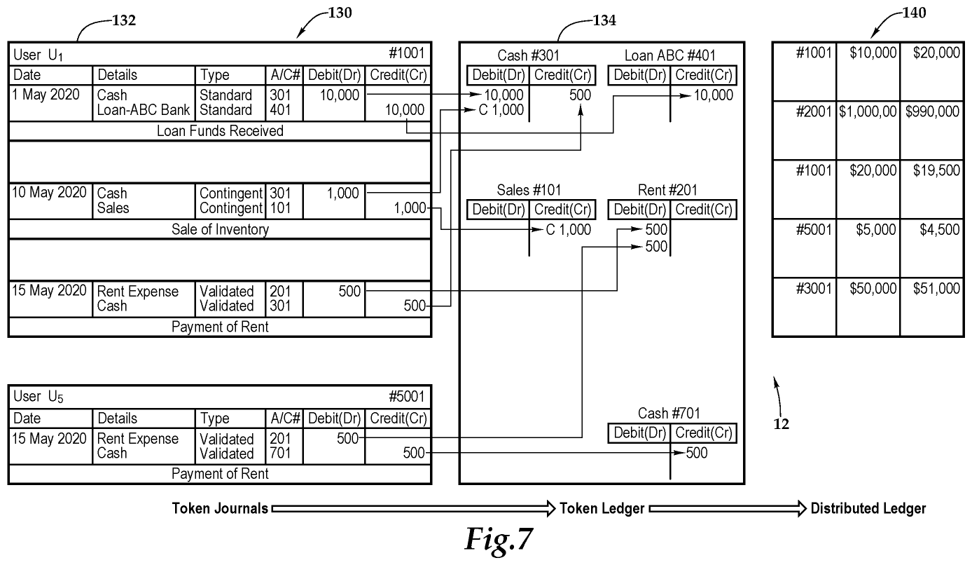

Referring now to FIG. 7, another conceptualization of the cryptocurrency token being utilized in a double-entry bookkeeping application is depicted. In this example, the user U₁ and a user U₅ are both liable for the rent, with each owing $500 as reflected by a contingent stored value created that is now validated. Both user U₁ and the user U₅ have respective accounts #1001 and #5001 debited by $500 as shown on the token journal portion 132, the token ledger portion 134, and the distributed ledger 140.

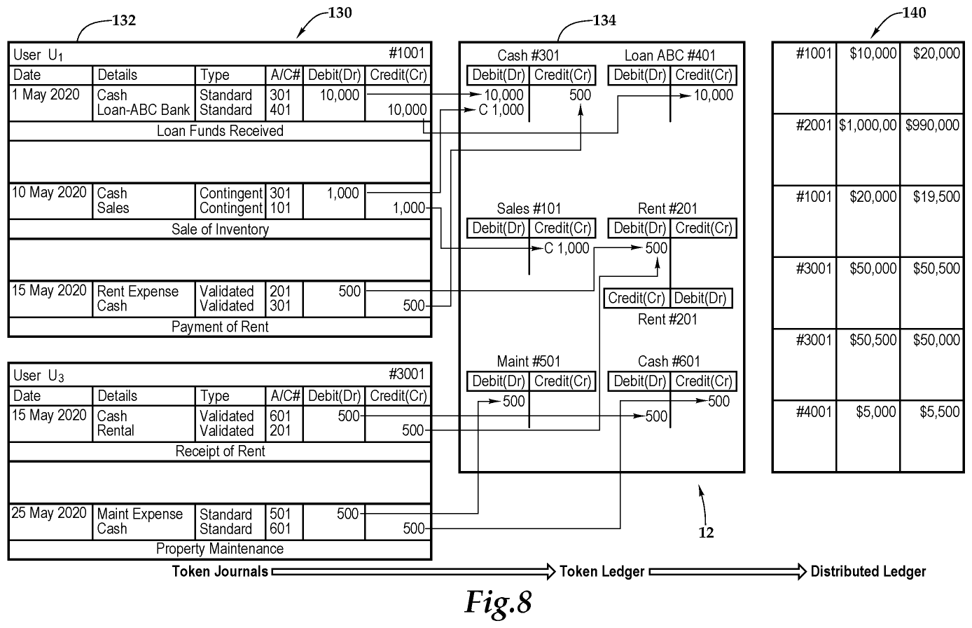

Referring now to FIG. 8, one conceptualization of the cryptocurrency token being utilized in a triple-entry bookkeeping application is depicted. As shown, the user U₁ pays a user U₃, who is the landlord, the rent. In the subledger 130 and, in one particular embodiment, the token ledger portion 134 shows the $500 rent debit of the user U₁ and the $500 rent credit of the user U₃ as the same entry, thereby utilizing triple-bookkeeping entries. That is, a credit to one member of the accounting journal token is shown as a debit to another member.

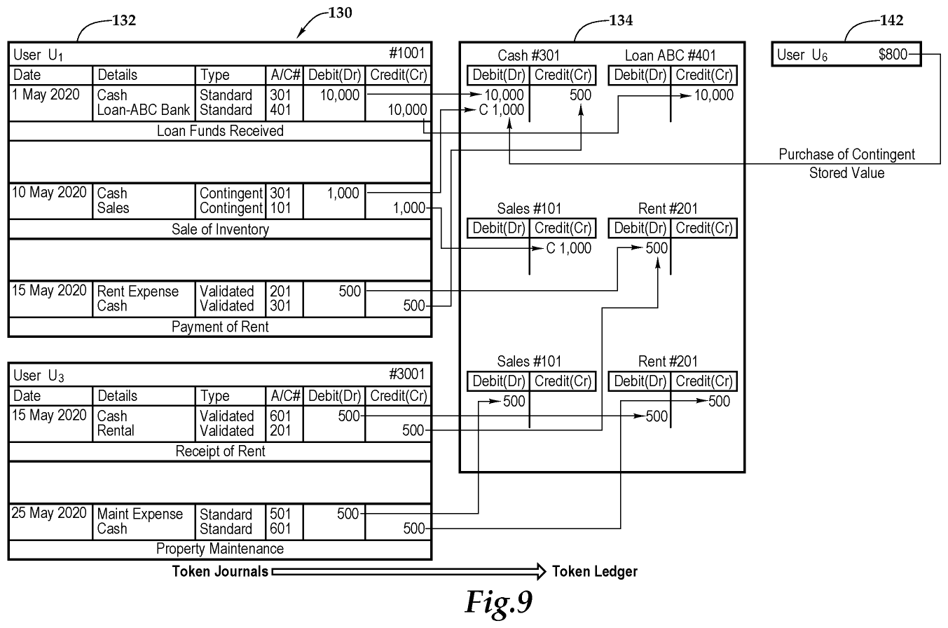

Referring now to FIG. 9, one conceptualization of cryptocurrency token being utilized in a fungible contingent stored value application is depicted. In this example, the user U1 has a contingent sale of inventory for $1,000, which is a contingent stored vale that is fungible. Through a purchase action 142 created by the cryptocurrency token 20, a user U6 has purchased the $1,000 credit for $800. This purchase would then be reflected on the distributed ledger 140 (not shown in FIG. 9) of the blockchain 12.

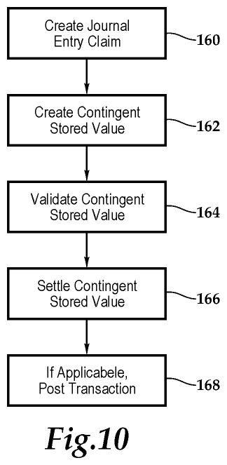

Referring now to FIG. 10, one embodiment of a method for utilizing the cryptocurrency token with the cryptocurrency protocol is presented. The methodology enables a user of the cryptocurrency token to create a contingent stored value, which may be fungible. Additionally, the methodology enables both double-entry bookkeeping and triple-entry bookkeeping. At block 160, a journal entry claim is created, which utilizes single-entry bookkeeping in a distributed accounting subledgers of the blockchain that is interfacing with the cryptocurrency token. At block 162, a contingent stored value is created with respect to claim. At this time, the single-entry bookkeeping claim is converted into a double-entry bookkeeping claim as, for example, the journal entry claim was created by a member of the cryptocurrency token or a non-member with the necessary approvals and validation by a member.

At block 164, the contingent stored value is validated prior to be settled at block 166. At block 168, if appropriate, the contingent stored value is posted in the distributed accounting ledger of the blockchain, which is more accessible and frequently found on a private or public blockchain.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

1. A cryptocurrency protocol comprising:
a smart contract running on a blockchain, the smart contract being shared logic to execute operations on the blockchain;
the blockchain storing a plurality of distributed accounting subledgers, each of the plurality of distributed accounting subledgers including a plurality of pairs of accounting entries, each of the plurality of pairs of accounting entries including a corresponding debit entry to a first account and credit entry to a second account;
the blockchain storing a plurality of distributed accounting ledgers, each of the plurality of distributed accounting ledgers including a plurality of pairs of accounting entries, each of the plurality of pairs of accounting entries including a corresponding debit entry to a first account and credit entry to a second account;
first processor-executable instructions stored in non-transitory memory accessible to a processor, the first processor-executable instructions, when executed, by the processor cause the cryptocurrency protocol to:
receive a contingent financial transaction request,
request from the smart contract a blockchain addition mapping to a distributed accounting subledger of interest, the distributed accounting subledger being one of the plurality of distributed accounting subledgers, the blockchain addition mapping including the contingent financial transaction request entered as an appended pair of contingent accounting entries including a corresponding debit entry and credit entry with validation detail data, and
if the appended pair of contingent accounting entries are validated, request from the smart contract a blockchain addition mapping to a distributed accounting ledger of interest, the distributed accounting ledger being one of the plurality of distributed accounting ledgers, the blockchain addition mapping including the contingent financial transaction request entered as an appended pair of accounting entries including the corresponding debit entry and credit entry.

2. The cryptocurrency protocol as recited in claim 1, further comprising second processor-executable instructions stored in the non-transitory memory accessible to the processor, the second processor-executable instructions, when executed, by the processor cause the cryptocurrency token to:
if the appended pair of contingent accounting entries are unvalidated, request from the smart contract a blockchain addition mapping to the distributed accounting subledger of interest, the blockchain addition mapping including the contingent financial transaction request re-entered as an appended pair of non-validated accounting entries including the corresponding debit entry and credit entry.

3. The cryptocurrency protocol as recited in claim 2, wherein the unvalidated state of the contingent accounting entries further comprises a state selected from the group consisting of pending and rejected.

4. The cryptocurrency protocol as recited in claim 1, wherein the validation detail data further comprises the stored contingent value required to satisfy at least a portion of the contingent financial transaction request.

5. The cryptocurrency protocol as recited in claim 1, further comprising second processor-executable instructions stored in the non-transitory memory accessible to the processor, the second processor-executable instructions, when executed, by the processor cause the cryptocurrency token to:
if the appended pair of contingent accounting entries are unvalidated, non-request to the smart contract a blockchain addition mapping to the distributed accounting ledger of interest.

6. The cryptocurrency protocol as recited in claim 1, further comprising second processor-executable instructions stored in the non-transitory memory accessible to the processor, the second processor-executable instructions, when executed, by the processor cause the cryptocurrency token to:
if the appended pair of contingent accounting entries are unvalidated, request from the smart contract a blockchain addition mapping to the distributed accounting subledger of interest, the blockchain addition mapping including the contingent financial transaction request re-entered as an appended pair of non-validated accounting entries including the corresponding debit entry and credit entry, and
if the appended pair of contingent accounting entries are unvalidated, non-request to the smart contract a blockchain addition mapping to the distributed accounting ledger of interest.

7. The cryptocurrency protocol as recited in claim 1, wherein the plurality of distributed accounting subledgers further comprises:
a first distributed accounting subledger belonging to a first party, the first distributed accounting subledger including a plurality of pairs of accounting entries, each of the plurality of pairs of accounting entries including a corresponding debit entry to a first account and credit entry to a second account;
a second distributed accounting subledger belonging to a second party, the second distributed accounting subledger including a plurality of pairs of accounting entries, each of the plurality of pairs of accounting entries including a corresponding debit entry to a first account and credit entry to a second account, the debit entry and credit entry having an identical timestamp; and
wherein one of the debit entries of the first distributed accounting ledger serves as one of the credit entries of the second distributed accounting ledger.

8. The cryptocurrency protocol as recited in claim 1, wherein, with respect to the plurality of distributed accounting subledgers, the first account further comprises an account selected from the group consisting of asset accounts, liability accounts, equity accounts, expense accounts, and revenue accounts.

9. The cryptocurrency protocol as recited in claim 1, wherein, with respect to the plurality of distributed accounting subledgers, the second account further comprises an account selected from the group consisting of asset accounts, liability accounts, equity accounts, expense accounts, and revenue accounts.

10. The cryptocurrency protocol as recited in claim 1, wherein, with respect to the plurality of distributed accounting subledgers, the first account and the second account further comprise different accounts, each selected from the group consisting of asset accounts, liability accounts, equity accounts, expense accounts, and revenue accounts.

11. The cryptocurrency protocol as recited in claim 1, wherein, with respect to the plurality of distributed accounting subledgers, the plurality of pairs of accounting entries are at least partially cryptographically sealed.

12. The cryptocurrency protocol as recited in claim 1, wherein, with respect to the plurality of distributed accounting subledgers, the debit entry and the credit entry having an identical timestamp.

13. The cryptocurrency protocol as recited in claim 1, wherein, with respect to the plurality of distributed accounting ledgers, the first account further comprises an account selected from the group consisting of asset accounts, liability accounts, equity accounts, expense accounts, and revenue accounts.

14. The cryptocurrency protocol as recited in claim 1, wherein, with respect to the plurality of distributed accounting ledgers, the second account further comprises an account selected from the group consisting of asset accounts, liability accounts, equity accounts, expense accounts, and revenue accounts.

15. The cryptocurrency protocol as recited in claim 1, wherein, with respect to the plurality of distributed accounting ledgers, the first account and the second account further comprise different accounts, each selected from the group consisting of asset accounts, liability accounts, equity accounts, expense accounts, and revenue accounts.

16. The cryptocurrency protocol as recited in claim 1, wherein, with respect to the plurality of distributed accounting ledgers, the plurality of pairs of accounting entries are at least partially cryptographically sealed.

17. The cryptocurrency protocol as recited in claim 1, wherein, with respect to the plurality of distributed accounting ledgers, the debit entry and the credit entry having an identical timestamp.

18. The cryptocurrency protocol as recited in claim 1, further comprising:
membership, the membership including a first member and a second member;
the plurality of distributed accounting subledgers being readable by the first member and the second member.

19. The cryptocurrency protocol as recited in claim 1, wherein the blockchain further comprises a blockchain selected from the group consisting of public blockchains and private blockchains.

20. A cryptocurrency protocol comprising:
a smart contract running on a blockchain, the smart contract being shared logic to execute operations on the blockchain;
the blockchain storing a plurality of distributed accounting subledgers, each of the plurality of distributed accounting subledgers including a plurality of pairs of accounting entries, each of the plurality of pairs of accounting entries including a corresponding debit entry to a first account and credit entry to a second account;
the blockchain storing a plurality of distributed accounting ledgers, each of the plurality of distributed accounting ledgers including a plurality of pairs of accounting entries, each of the plurality of pairs of accounting entries including a corresponding debit entry to a first account and credit entry to a second account;
first processor-executable instructions stored in non-transitory memory accessible to a processor, the first processor-executable instructions, when executed, by the processor cause the cryptocurrency protocol to:
receive a contingent financial transaction request,
request from the smart contract a blockchain addition mapping to a distributed accounting subledger of interest, the distributed accounting subledger being one of the plurality of distributed accounting subledgers, the blockchain addition mapping including the contingent financial transaction request entered as an appended pair of contingent accounting entries including a corresponding debit entry and credit entry with validation detail data,
enable fungibility of the pair of contingent accounting entries including a corresponding debit entry and credit entry with validation detail data, and
if the appended pair of contingent accounting entries are validated, request from the smart contract a blockchain addition mapping to a distributed accounting ledger of interest, the distributed accounting ledger being one of the plurality of distributed accounting ledgers, the blockchain addition mapping including the contingent financial transaction request entered as an appended pair of accounting entries including the corresponding debit entry and credit entry.

21. The cryptocurrency protocol as recited in claim 20, wherein the plurality of distributed accounting subledgers further comprises:
a first distributed accounting subledger belonging to a first party, the first distributed accounting subledger including a plurality of pairs of accounting entries, each of the plurality of pairs of accounting entries including a corresponding debit entry to a first account and credit entry to a second account;
a second distributed accounting subledger belonging to a second party, the second distributed accounting subledger including a plurality of pairs of accounting entries, each of the plurality of pairs of accounting entries including a corresponding debit entry to a first account and credit entry to a second account, the debit entry and credit entry having an identical timestamp; and
wherein one of the debit entries of the first distributed accounting ledger serves as one of the credit entries of the second distributed accounting ledger.

22. A cryptocurrency protocol comprising:
a smart contract running on a blockchain, the smart contract being shared logic to execute operations on the blockchain;
the blockchain storing a plurality of distributed accounting subledgers, each of the plurality of distributed accounting subledgers including a plurality of pairs of accounting entries, each of the plurality of pairs of accounting entries including a corresponding debit entry to a first account and credit entry to a second account;
the blockchain storing a plurality of distributed accounting ledgers, each of the plurality of distributed accounting ledgers including a plurality of pairs of accounting entries, each of the plurality of pairs of accounting entries including a corresponding debit entry to a first account and credit entry to a second account;
first processor-executable instructions stored in non-transitory memory accessible to a processor, the first processor-executable instructions, when executed, by the processor cause the cryptocurrency protocol to:
receive a contingent financial transaction request,
request from the smart contract a blockchain addition mapping to a distributed accounting subledger of interest, the distributed accounting subledger being one of the plurality of distributed accounting subledgers, the blockchain addition mapping including the contingent financial transaction request entered as an appended pair of contingent accounting entries including a corresponding debit entry and credit entry with validation detail data, and
if the appended pair of contingent accounting entries are at least partially validated, request from the smart contract a blockchain addition mapping to a distributed accounting ledger of interest, the distributed accounting ledger being one of the plurality of distributed accounting ledgers, the blockchain addition mapping including the contingent financial transaction request proportionately entered, in accordance with the partial validation, as an appended pair of accounting entries including the corresponding debit entry and credit entry.

23. The cryptocurrency protocol as recited in claim 22, wherein the plurality of distributed accounting subledgers further comprises:
a first distributed accounting subledger belonging to a first party, the first distributed accounting subledger including a plurality of pairs of accounting entries, each of the plurality of pairs of accounting entries including a corresponding debit entry to a first account and credit entry to a second account;
a second distributed accounting subledger belonging to a second party, the second distributed accounting subledger including a plurality of pairs of accounting entries, each of the plurality of pairs of accounting entries including a corresponding debit entry to a first account and credit entry to a second account, the debit entry and credit entry having an identical timestamp; and
wherein one of the debit entries of the first distributed accounting ledger serves as one of the credit entries of the second distributed accounting ledger.
